(19) United States
(12) Patent Application Publication
(10) Pub. No.: US 2026/0371073 A1
(43) Pub. Date: Nov. 19, 2026

(54) DEVICE AND METHOD FOR PROTECTING CONTROL FRAME IN WIRELESS LOCAL AREA NETWORK

(71) Applicant: FRONTSIDE LLC, Seoul (KR)

(72) Inventor: Jeong Soo LEE, Gyeonggi-do (KR)

(21) Appl. No.: 19/124,398

(22) PCT Filed: Oct. 12, 2023
(86) PCT No.: PCT/KR2023/015722

§ 371 Date: Apr. 25, 2025

(30) Foreign Application Priority Data
Oct. 28, 2022 (KR) 10-2022-0140822
Feb. 13, 2023 (KR) 10-2023-0018783

(51) Int. Cl. H04W 12/033; H04W 12/0431; H04W 12/06; H04W 12/106; H04W 76/10; H04W 84/12

(52) U.S. Cl. CPC H04W 12/033; H04W 12/0431; H04W 12/06; H04W 12/106; H04W 76/10; H04W 84/12

(57) ABSTRACT

A device for protecting a control frame in a wireless local area network is provided. The device receives an initial control frame that includes integrity check information to calculate message integrity check (MIC) for protecting an integrity of the initial control frame. The device derives a first MIC from the initial control frame and determines a second MIC based in part on the initial control frame. The device determines whether the initial control frame is actually transmitted by the devices's associated access point based on the first MIC and the second MIC.

### TECHNICAL FIELD

The present disclosure relates to a wireless local area network (WLAN), and more particularly, to a method for protecting a control frame in the WLAN and a device using the same.

### BACKGROUND ART

A wireless local area network (WLAN) may be formed by one or more access points (APs) that provide a shared wireless communication medium for use by a number of client devices also referred to as stations (STAs).

Orthogonal frequency division multiple access (OFDMA) is a multiple access scheme where different subsets of subcarriers are allocated to different users, and this scheme allows simultaneous data transmission to or from one or more users.

A physical layer protocol data unit (PPDU) is a data unit (or data packet) to carry various information in the WLAN. In OFDMA, users are allocated different subsets of subcarriers that can change from one PPDU to the next. Using OFDMA, an AP may allocate different RUs for STAs. The AP can simultaneously transmit various formats of PPDUs to multiple STAs.

Message Integrity Check (MIC) prevents attacks on encrypted packets called bit-flip attacks. During a bit-flip attack, an intruder intercepts an encrypted message, alters it slightly, and retransmits it, and the receiver accepts the retransmitted message as legitimate. The MIC, implemented on both the AP and all associated STAs, can add a few bytes to each packet to make the packets tamper-proof.

### DISCLOSURE OF INVENTION

### Technical Problem

The present disclosure provides a method for protecting a control frame in a wireless local area network.

The present disclosure further provides a device for protecting a control frame in a wireless local area network.

### Solution to Problem

In an aspect, a method for protecting a control frame in a wireless local area network is provided. The method includes establishing a connection with an access point (AP), receiving an initial control frame, the initial control frame including integrity check information to calculate message integrity check (MIC) for protecting an integrity of the initial control frame, the integrity check information including a first MIC, determining a second MIC based in part on the initial control frame, and determining whether the initial control frame is actually transmitted by the AP based on the first MIC and the second MIC. The initial control frame further includes a protection present subfield indicating that the integrity check information is present in the initial control frame.

In another aspect, a device for a wireless local area network, the device includes a processor, and a memory operatively coupled with the processor and configured to store instructions that, when executed by the processor, cause the device to perform functions. The functions includes establishing a connection with an access point (AP), receiving an initial control frame, the initial control frame including integrity check information to calculate message integrity check (MIC) for protecting an integrity of the initial control frame, the integrity check information including a first MIC, determining a second MIC based in part on the initial control frame, and determining whether the initial control frame is actually transmitted by the AP based on the first MIC and the second MIC. The initial control frame further includes a protection present subfield indicating that the integrity check information is present in the initial control frame.

### Advantageous Effects of Invention

As new WLAN communication protocols enable enhanced features, new PPDU transmission designs are provided to support signaling regarding features and resource allocations.

### BRIEF DESCRIPTION OF DRAWINGS

FIG. 1 shows a block diagram of an example wireless communication network.

FIG. 2 shows a block diagram of an example wireless communication device.

FIG. 3 shows an example of UL MU transmission.

FIG. 4 shows an example of multi-link operation.

FIG. 5 shows an example of an enhanced multi-link single radio operation.

FIG. 6 shows an example of contents in EML Operating Mode Notification frame.

FIG. 7 shows an example of attacking using an initial control frame.

FIG. 8 shows an example of trigger frame format according an embodiment of the present disclosure.

FIG. 9 shows a protection of an initial control frame according an embodiment of the present disclosure.

### MODE FOR THE INVENTION

The following description is directed to certain implementations for the purposes of describing innovative aspects of this disclosure. However, a person having ordinary skill in the art will readily recognize that the teachings herein can be applied in a multitude of different ways. The described implementations can be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3rd Generation Partnership Project (3GPP), among others. The described implementations can be implemented in any device, system or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), single-user (SU) multiple-input multiple-output (MIMO) and multi-user (MU) MIMO. The described implementations also can be implemented using other wireless communication protocols or RF signals suitable for use in one or more of a wireless personal area network (WPAN), a wireless local area network (WLAN), a wireless wide area network (WWAN), or an internet of things (IOT) network.

OFDMA is an OFDM-based multiple access scheme where different subsets of subcarriers are allocated to different users, and this scheme allows simultaneous data transmission to or from one or more users. In OFDMA, users are allocated different subsets of subcarriers that can change from one PPDU to the next. Similar to OFDM, OFDMA employs multiple subcarriers, but the subcarriers are divided into several groups where each group is referred to as a resource unit (RU).

A physical layer protocol data unit (PPDU) may span one or more subchannels and may include a preamble portion and a data portion. Signaling refers to control fields or information in the preamble portion that can be used by a wireless communication device to interpret another field or portion of the preamble portion or the data portion of the PPDU. A wireless channel may be formed from multiple subchannels. A subchannel may include a set of subcarriers. Portions of the wireless channel bandwidth can be divided or grouped to form different resource units (RUs). An RU may be a unit for resource allocation and may include one or more subcarriers. Among other things, a preamble portion of a PPDU may include signaling to indicate which RUs are allocated to different devices. Other types of signaling include indicators regarding which subchannels include further signaling or which subchannels may be punctured. There are several formats of PPDUs (and related structures) defined for current wireless communication protocols. As new wireless communication protocols enable enhanced features, new preamble designs are needed support signaling regarding features and resource allocations. Furthermore, it desirable to define a new preamble signaling protocol that can support future wireless communication protocols.

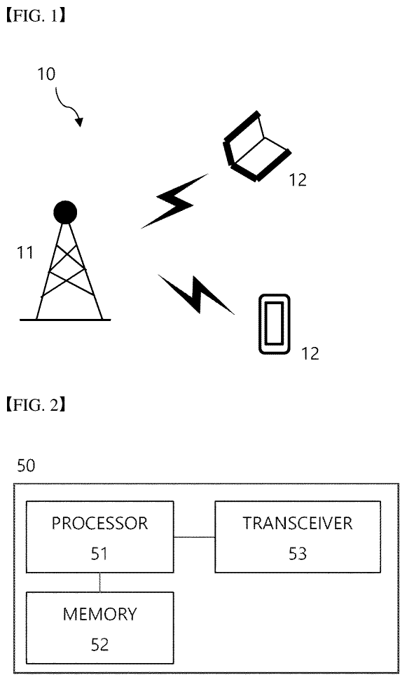

FIG. 1 shows a block diagram of an example wireless communication network.

According to some aspects, the wireless communication network 10 can be an example of a wireless local area network (WLAN) such as a Wi-Fi network (and will hereinafter be referred to as WLAN 10). For example, the WLAN 10 can be a network implementing at least one of the IEEE 802.11 family of wireless communication protocol standards (such as that defined by the IEEE 802.11-2016 specification or amendments thereof including, but not limited to, 802.11ah, 802.11ad, 802.11ay, 802.11ax, 802.11az, 802.11ba and 802.11be). The WLAN 10 may include numerous wireless communication devices such as an access point (AP) 11 and multiple stations (STAs) 12. While only one AP 11 is shown, the WLAN network 10 also can include multiple APs.

Each of the STAs 12 also may be referred to as a mobile station (MS), a mobile device, a mobile handset, a wireless handset, an access terminal (AT), a user equipment (UE), a subscriber station (SS), or a subscriber unit, among other possibilities. The STAs 12 may represent various devices such as mobile phones, personal digital assistant (PDAs), other handheld devices, netbooks, notebook computers, tablet computers, laptops, display devices (for example, TVs, computer monitors, navigation systems, among others), music or other audio or stereo devices, remote control devices (“remotes”), printers, kitchen or other household appliances, key fobs (for example, for passive keyless entry and start (PKES) systems), among other possibilities.

A single AP 11 and an associated set of STAs 12 may be referred to as a basic service set (BSS), which is managed by the respective AP 11. The BSS may be identified to users by a service set identifier (SSID), as well as to other devices by a basic service set identifier (BSSID), which may be a medium access control (MAC) address of the AP 11. The AP 11 periodically broadcasts beacon frames (“beacons”) including the BSSID to enable any STAs 12 within wireless range of the AP 11 to “associate” or re-associate with the AP 11 to establish a respective communication link (hereinafter also referred to as a “Wi-Fi link”), or to maintain a communication link, with the AP 11. For example, the beacons can include an identification of a primary channel used by the respective AP 11 as well as a timing synchronization function for establishing or maintaining timing synchronization with the AP 11. The AP 11 may provide access to external networks to various STAs 12 in the WLAN via respective communication link.

To establish a communication link with an AP 11, each of the STAs 12 is configured to perform passive or active scanning operations (“scans”) on frequency channels in one or more frequency bands (for example, the 2.4 GHZ, 5 GHZ, 6 GHz or 60 GHZ bands). To perform passive scanning, a STA 12 listens for beacons, which are transmitted by respective APs 11 at a periodic time interval referred to as the target beacon transmission time (TBTT) (measured in time units (TUs) where one TU may be equal to 1024 microseconds (μs)). To perform active scanning, a STA 12 generates and sequentially transmits probe requests on each channel to be scanned and listens for probe responses from APs 11. Each STA 12 may be configured to identify or select an AP 11 with which to associate based on the scanning information obtained through the passive or active scans, and to perform authentication and association operations to establish a communication link with the selected AP 11. The AP 11 assigns an association identifier (AID) to the STA 12 at the culmination of the association operations, which the AP 11 uses to track the STA 104.

In some cases, STAs 12 may form networks without APs 11 or other equipment other than the STA. One example of such a network is an ad hoc network (or wireless ad hoc network). Ad hoc networks may alternatively be referred to as mesh networks or peer-to-peer (P2P) networks. In some cases, ad hoc networks may be implemented within a larger wireless network such as the WLAN 10. In such implementations, while the STAs 12 may be capable of communicating with each other through the AP 11 using communication links, STAs 12 also can communicate directly with each other via direct wireless links. Additionally, two STAs 12 may communicate via a direct communication link regardless of whether both STAs 12 are associated with and served by the same AP 11. In such an ad hoc system, one or more of the STAs 12 may assume the role filled by the AP 11 in a BSS. Such a STA may be referred to as a group owner (GO) and may coordinate transmissions within the ad hoc network.

The AP 11 and STAs 12 may function and communicate (via the respective communication links) according to the IEEE 802.11 family of wireless communication protocol standards (such as that defined by the IEEE 802.11-2016 specification or amendments thereof including, but not limited to, 802.11ah, 802.11ad, 802.11ay, 802.11ax, 802.11az, 802.11ba and 802.11be). These standards define the WLAN radio and baseband protocols for the PHY and medium access control (MAC) layers. The AP 11 and STAs 12 transmit and receive wireless communications (hereinafter also referred to as “Wi-Fi communications”) to and from one another in the form of PPDUs. The AP 11 and STAs 12 in the WLAN 10 may transmit PPDUs over an unlicensed spectrum, which may be a portion of spectrum that includes frequency bands traditionally used by Wi-Fi technology, such as the 2.4 GHz band, the 5 GHz band, the 60 GHz band, the 3.6 GHz band, and the 900 MHz band. Some implementations of the AP 11 and STAs 12 described herein also may communicate in other frequency bands, such as the 6 GHz band, which may support both licensed and unlicensed communications. The AP 11 and STAs 12 also can be configured to communicate over other frequency bands such as shared licensed frequency bands, where multiple operators may have a license to operate in the same or overlapping frequency band or bands.

Each of the frequency bands may include multiple channels (which may be used as subchannels of a larger bandwidth channel). For example, PPDUs conforming to the IEEE 802.11n, 802.11ac and 802.11ax standard may be transmitted over the 2.4 and 5 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 or 320 MHz by bonding together multiple 20 MHz channels (which may be referred to as subchannels).

Each PPDU is a composite structure that includes a PHY preamble and a payload in the form of a PHY service data unit (PSDU). The information provided in the preamble may be used by a receiving device to decode the subsequent data in the PSDU. In instances in which PPDUs are transmitted over a bonded channel, the preamble fields may be duplicated and transmitted in each of the multiple component channels. The PHY preamble may include both a first portion (or “legacy preamble”) and a second portion (or “non-legacy preamble”). The first portion may be used for packet detection, automatic gain control and channel estimation, among other uses. The first portion also may generally be used to maintain compatibility with legacy devices as well as non-legacy devices. The format of, coding of, and information provided in the second portion of the preamble is based on the particular IEEE 802.11 protocol to be used to transmit the payload.

Uplink (UL) means that the signal (or message or PPDU) is transmitted by a STA to an AP, and downlink (DL) means that the signal (or message or PPDU) is transmitted by the AP to one or more STAs.

FIG. 2 shows a block diagram of an example wireless communication device.

In some implementations, the wireless communication device 50 can be an example of a device for use in a STA such as one of the STAs 12 described above with reference to FIG. 1. In some implementations, the wireless communication device 50 can be an example of a device for use in an AP such as the AP 11 described above with reference to FIG. 1. The wireless communication device 50 is capable of transmitting (or outputting for transmission) and receiving wireless communications (for example, in the form of wireless packets). For example, the wireless communication device can be configured to transmit and receive packets in the form of PPDUs and/or medium access control (MAC) protocol data units (MPDUs) conforming to an IEEE 802.11 wireless communication protocol standard, such as that defined by the IEEE 802.11-2016 specification or amendments thereof including, but not limited to, 802.11ah, 802.11ad, 802.11ay, 802.11ax, 802.11az, 802.11ba and 802.11be.

The wireless communication device 50 can be, or can include, a chip, system on chip (SoC), chipset, package or device that includes one or more processor 51. The processor 51 can include an intelligent hardware block or device such as, for example, a processing core, a processing block, a central processing unit (CPU), a micro-processor, a microcontroller, a digital signal processor (DSP), an application-specific integrated circuit (ASIC), a programmable logic device (PLD) such as a field programmable gate array (FPGA), discrete gate or transistor logic, discrete hardware components, or any combination thereof designed to perform the functions described herein. The processor 51 processes information received through a transceiver 53, and processes information to be output through the transceiver 53 through the wireless medium. For example, the processor 806 may implement a physical (PHY) layer and/or a MAC layer configured to perform various operations related to the generation and transmission of PPDUs, MPDUs, frames or packets.

A memory 52 can include tangible storage media such as random-access memory (RAM) or read-only memory (ROM), or combinations thereof. The memory 808 also can store non-transitory processor-or computer-executable software code containing instructions that, when executed by the processor 51, cause the wireless communication device 50 to perform various operations described herein for wireless communication, including the generation, transmission, reception and interpretation of PPDUs, MPDUs, frames or packets. For example, various functions of components disclosed herein, or various blocks or steps of a method, operation, process or algorithm disclosed herein, can be implemented as one or more modules of one or more computer programs.

The transceiver 53 generally includes at least one radio frequency (RF) transmitter (or “transmitter chain”) for transmitting radio signals and at least one RF receiver (or “receiver chain”) for receiving radio signals. For example, the RF transmitters and receivers may include various DSP circuitry including at least one power amplifier (PA) and at least one low-noise amplifier (LNA), respectively. The RF transmitters and receivers may, in turn, be coupled to one or more antennas. For example, in some implementations, the wireless communication device 50 can include, or be coupled with, multiple transmit antennas (each with a corresponding transmit chain) and multiple receive antennas (each with a corresponding receive chain).

Very high throughput (VHT) is used to represent IEEE 802.11ac, high efficiency (HE) is used to represent IEEE 802.11ax, extremely high throughput (EHT) is used to represent IEEE 802.11be. EHT STA may be used to represent a STA supporting at least EHT. EHT STA can further support VHT and/or HE.

‘UHR’ is used to represent any later (post-EHT) version of a new wireless communication protocol conforming to a future IEEE 802.11 wireless communication protocol standard or other standard, and is for illustration purpose only. ‘UHR’ may be referred to as other terms, for example, Ultra Low Latency (ULL), High Reliability (HR), etc. The UHR PPDU may support future amendments to the IEEE 802.11 wireless communication standard.

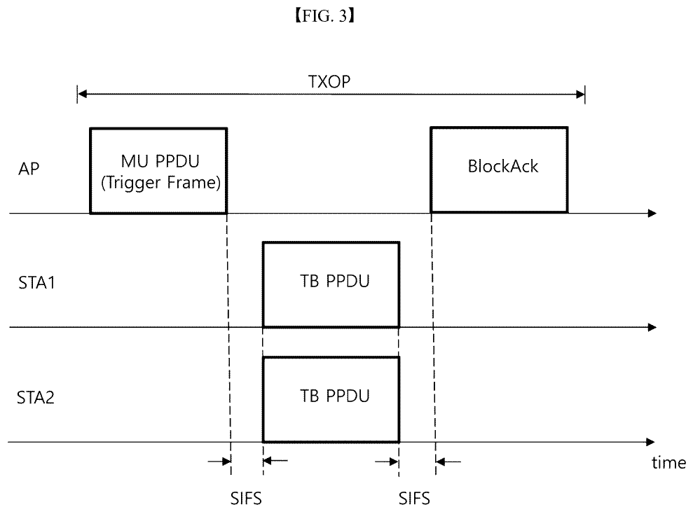

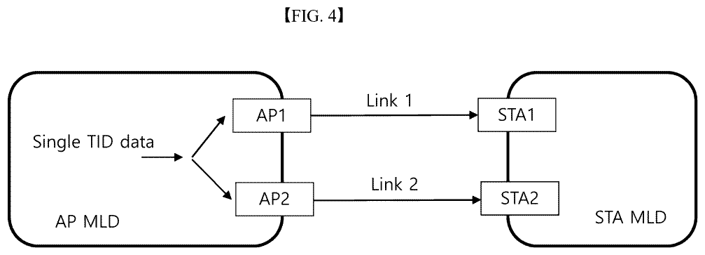

FIG. 3 shows an example of UL MU transmission.

UL MU operation allows an AP to solicit simultaneous immediate response frames from one or more STAs.

The AP may send a trigger frame to one or more STAs (for example, STA1 and STA2). The trigger frame may be sent as MU PPDU (for example, HE MU PPDU or EHT MU PPDU). The STA1 and STA2 may send response PDUs (for example, HE TB PPDU or EHT TB PPDU) in response to the trigger frame. The interframe space between a PPDU that contains a triggering frame and the TB PPDU is a Short Interframe Space (SIFS). The AP sends an Ack or BlockAck frame acknowledging the one or more TB PPDUs to the response STAs (for example, STA1 and STA2).

The trigger frame allocates resources for and solicits one or more PPDU transmissions. The trigger frame also carries other information required by the responding STA to send a TB PPDU or a non-HT PPDU. The trigger frame may be sent as various types such as a basic trigger frame, multi-user request to send (MU-RTS) frame, multi-user block ack request (MU-BAR) frame, Beamforming Report Poll (BFRP) Trigger frame, etc.

The trigger frame may include a UL bandwidth field, an CS required field, one or more STA IDs and one or more resource unit (RU) Allocation field. The UL bandwidth field indicates the bandwidth of the response PPDU. The CS required field indicate whether the response STAs are required to use energy detection (ED) to sense the medium and to consider the medium state and the network allocation vector (NAV) in determining whether or not to respond. The one or more STA IDs identifies the one or more response STAs. The RU Allocation subfield indicates RU allocation for the response PPDU.

A NAV is an indicator, maintained by each STA, of time periods when transmission onto the wireless medium (WM) is not initiated by the STA regardless of whether the STA's clear channel assessment (CCA) function senses that the WM is busy. Transmission opportunity (TXOP) is an interval of time during which a particular STA has the right to initiate frame exchange sequences onto the WM.

A WLAN device classify a received PPDU as an inter-PPDU if (i) the received PPDU is transmitted by an AP which is not associated with the WLAN device, (ii) the received PPDU's BSS is not the BSS of the WLAN device, or (iii) the received PPDU is a downlink MU PPDU and the WLAN device is an AP.

A WLAN device classify a received PPDU as an intra-PPDU if (i) the received PPDU is transmitted by an AP which is associated with the WLAN device, (ii) the received PPDU's BSS is the BSS of the WLAN device, or (iii) the received PPDU is a downlink MU PPDU and the WLAN device is an AP.

Timing synchronization function (TSF) keeps TSF timers for all stations in the same BSS synchronized. STAs can maintain a local TSF timer. Each STA can maintain a TSF timer with modulus 264 counting in increments of microseconds. The AP is the timing master for the TSF. The AP can periodically transmit beacon frames which contain the value of the AP's TSF timer in order to synchronize the TSF timers of other STAs in a BSS. A receiving STA can accept the timing information in the beacon frames and can update the receiving STA's TSF timer. If the receiving STA's TSF timer is different from the timestamp in the received beacon frame, the receiving STA can set its local TSF timer to the received timestamp value.

FIG. 4 shows an example of multi-link operation.

In order to optimize the system spectrum utilization and achieve better throughput performance, the IEEE 802.11be has defined multi-link operation (MLO) to support sending data frames concurrently on multiple links. MLO allows the users to enjoy the multilink benefits unavailable for a simple noncontiguous wide spectrum on a single link, such as asynchronous channel access and enhanced power save. The MLO can aggregate a various number of links of different widths. For example, Link1 has a bandwidth of 160 MHz and Link2 has a bandwidth of 40 MHz. Despite having multiple PHY/MAC interfaces, MLD has a single MAC address and uses this MAC address as its own identity. MLO enables frame transmission and retransmission on any link regardless of the link of the initial transmission of the frame.

A multi-link device (MLD) may be a logical entity that is capable of supporting more than one affiliated STA and can operate using one or more affiliated STAs, and that presents one medium access control (MAC) data service and a single MAC-service access point (SAP) to the logical link control (LLC) sublayer. An affiliated AP is an affiliated STA that is an AP STA and the corresponding MLD is an AP MLD. An affiliated STA is a STA, which can be an AP STA or non-AP STA, that provides link-specific, lower MAC and physical layer (PHY) services within an MLD.

An enabled link is a setup link of a non-AP MLD to which at least one traffic identifier (TID) is mapped either in downlink or in uplink. A disabled link is a setup link of a non-AP MLD to which no TID is mapped neither in downlink nor in uplink. A TID is any of the identifiers usable by higher layer entities to distinguish MAC service data units (MSDUs) to MAC entities that support quality of service (QOS) within the MAC data service.

If an MLD implements multiple radios and uses these multiple radios concurrently for the MLO, these devices are defined as multilink multiradio (MLMR) MLD. If an MLD only implements single radio and still wants to operate multiple links, then these devices are called multilink single-radio (MLSR) MLD.

An AP MLD may include multiple APs each capable of communicating on multiple communication links and may establish a BSS on the multiple communication links. A STA MLD may include multiple STAs capable of communicating with other devices (such as an AP MLD) on multiple communication links. If congestion on a first communication link is above a certain level, the MLDs may switch from communicating on the first communication link to communicating on a second communication link. In some implementations, associating with one another on one communication link allows the MLDs to use the same association configuration, encryption keys, and other ML communication parameters when communicating on one or more of the other communication links associated with the MLDs.

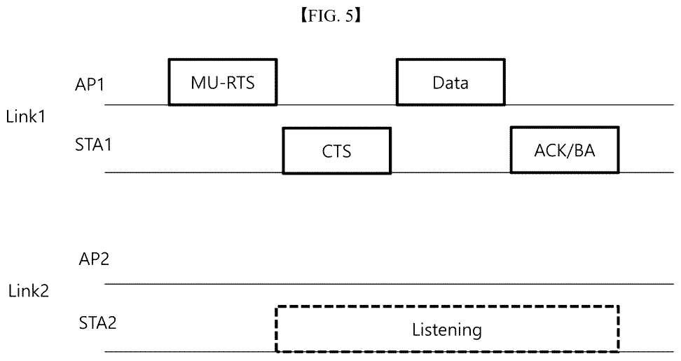

FIG. 5 shows an example of an enhanced multi-link single radio operation.

Enhanced multi-link single radio (EMLSR) operation is a mode of operation that allows a non-AP MLD with multiple receive chains to listen on a set of enabled links when the corresponding STAs affiliated with the non-AP MLD are in the awake state for an initial Control frame (for example, a trigger frame sent by an AP affiliated with an AP MLD, followed by frame exchanges on the link on which the initial Control frame was received).

Assuming that AP MLD includes AP1 and AP2 as affiliated APs, and STA MLD includes STA1 and STA2 as affiliated STAs. When an AP MLD intends to conduct EMLSR operation with an EMLSR STA MLD, each AP within the AP MLD tries to access the corresponding band/channel by running EDCA function independently. In this example, AP1 of the AP MLD is operating on the 6 GHz band (Link1) and AP2 is operating on the 5 GHz band (Link2). If the EDCA function completes the backoff procedure, the corresponding AP starts frame exchange procedure by sending Initial Control Frame (ICF). In this example, AP1 on the 6 GHz band completes backoff, so AP1 sends a MU-RTS frame to start EMLSR operation. When AP1 on the 6 GHz band sends out MU-RTS, STA1 of STA MLD receives the MU-RTS and understands the following DL data transmission which will be carried out on the 6 GHz band.

EMLSR operation can provide throughput enhancement and latency reduction similar to that of concurrent dual-radio MLDs. EMLSR operation enables a wireless device having a single radio to receive data using multiple channels/links. When a wireless device is operating in the EMLSR mode with an AP that supports the EMLSR mode, the device can listen on the enabled links by leaving its affiliated wireless STAs corresponding to those links in an awake state (“listening mode”). The listening operation can include performing clear channel assessment (CCA) and receiving an initial control frame of a frame exchange sequence that is initiated by an AP MLD.

A non-AP MLD may operate in the EMLSR mode on a specified set of the enabled links between the non-AP MLD and its associated AP MLD. The specified set of the enabled links in which the EMLSR mode is applied is called EMLSR links. The EMLSR links can be indicated in the EMLSR Link Bitmap subfield of the EML Control field of the EML Operating Mode Notification frame by setting the bit positions of the EMLSR Link Bitmap subfield to 1. For the EMLSR mode enabled in a single-radio non-AP MLD, the STA(s) affiliated with the non-AP MLD that operates on the link(s) that corresponds to the bit position(s) of the EMLSR Link Bitmap subfield set to 0 may be in doze state if a STA affiliated with the non-AP MLD that operates on one of the EMLSR links is in awake state.

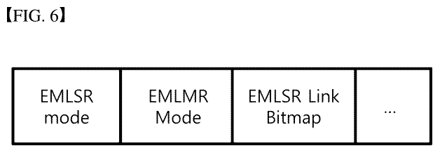

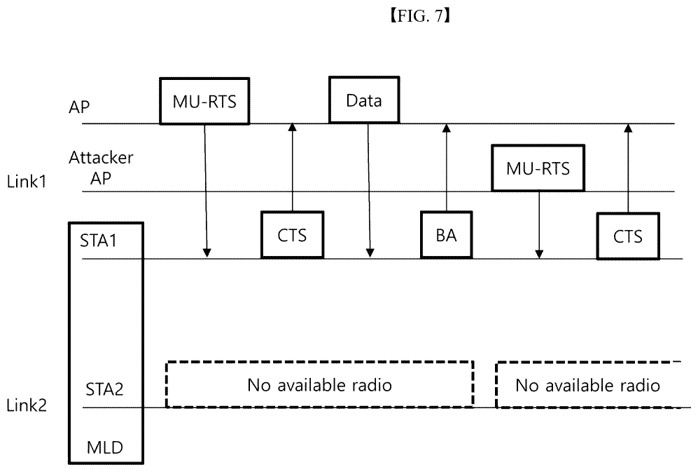

FIG. 6 shows an example of contents in EML Operating Mode Notification frame.

The EML Operating Mode Notification frame is used to indicate that a non-AP MLD with which the transmitting STA is affiliated is changing its EML operation.

A non-AP MLD that supports EMLSR operation sets the EMLSR Mode subfield to 1 to indicate that the non-AP MLD operates in EMLSR mode and to 0 to indicate that the non-AP MLD does not operate in EMLSR mode. The EMLSR Mode subfield is set to 0 if the enhanced multi-link multi-radio (EMLMR) Mode subfield is set to 1. An AP MLD that receives an EML Operating Mode Notification frame from a STA affiliated with a non-AP MLD sets the EMLSR Mode subfield of the EML Operating Mode Notification frame that is sent in response to the value obtained from the received EML Operating Mode Notification frame.

The EMLSR Link Bitmap subfield indicates the subset of the enabled links that is used by the non-AP MLD in the EMLSR mode. The bit position i of the EMLSR Link Bitmap subfield corresponds to the link with the Link ID equal to i and is set to 1 to indicate that the link is used by the non-AP MLD for the EMLSR mode and is a member of the EMLSR links; otherwise the bit position is set to 0.

When a non-AP MLD intends to operate in the EMLSR mode on the EMLSR links, a STA affiliated with the non-AP MLD can transmit an EML Operating Mode Notification frame with the EMLSR Mode subfield of the EML Control field of the frame set to 1 to an AP affiliated with an AP MLD. An AP affiliated with the AP MLD that received the EML Operating Mode Notification frame from the STA affiliated with the non-AP MLD can transmit an EML Operating Mode Notification frame to one of the STAs affiliated with the non-AP MLD within a timeout interval.

When a non-AP MLD is operating in the EMLSR mode with an AP MLD supporting the EMLSR mode, the non-AP MLD can be able to listen on the EMLSR links, by having its affiliated STA(s) corresponding to those links in awake state. The listening operation includes CCA and receiving the initial Control frame of frame exchanges that is initiated by the AP MLD. An AP affiliated with the AP MLD that initiates frame exchanges with the non-AP MLD on one of the EMLSR links can begin the frame exchanges by transmitting the initial Control frame to the non-AP MLD. The initial Control frame may be a MU-RTS Trigger frame or a BSRP Trigger frame. A STA affiliated with a non-AP MLD that is in the listening operation and that receives an MU-RTS Trigger Frame or BSRP Trigger frame addressed to it can respond except when the frame exchanges initiated by the initial Control frame on one of the EMLSR links overlaps with group addressed frame transmissions on the other EMLSR link where the non-AP STA intends to receive the group addressed frames.

After receiving the initial Control frame for initiating frame exchanges and transmitting an immediate response frame as a response to the initial Control frame, a STA affiliated with the non-AP MLD that was listening on the corresponding link can be able to transmit or receive frames on the link in which the initial Control frame was received and cannot transmit or receive on the other EMLSR link(s) until the end of the frame exchanges. The STA affiliated with the non-AP MLD can be capable of receiving a PPDU that is sent using more than one spatial stream on the link in which the initial Control frame was received a SIFS after the end of its response frame transmission solicited by the initial Control frame. During the frame exchanges, the other AP(s) affiliated with the AP MLD may not transmit frames to the other STA(s) affiliated with the non-AP MLD on the other EMLSR link(s).

The AP affiliated with the AP MLD can transmit before the TXNAV timer expires another initial Control frame addressed to the STA affiliated with the non-AP MLD if the AP intends to continue the frame exchanges with the STA and did not receive the response frame from this STA for the most recently transmitted frame that requires an immediate response after a SIFS.

Only one STA affiliated with the non-AP MLD that is operating on one of the EMLSR links may initiate frame exchanges with the AP MLD.

IEEE 802.11 standard defines counter mode (CTR) with cipher-block chaining message authentication code (CBC-MAC) protocol (CCMP) as one of robust security network association (RSNA) to provide data confidentiality, authentication, integrity, and replay protection. CCMP is based on the CTR with CBC-MAC (CCM) of the Advanced Encryption Standard (AES) encryption algorithm. CCM combines CTR for data confidentiality and CBC-MAC for authentication and integrity. CCM can protect the integrity of both the MPDU Data field and selected portions of the IEEE 802.11 MPDU header.

CCM is a generic mode that can be used with any block-oriented encryption algorithm. CCM may have two parameters, M and L. CCMP-128 uses M=8 (indicating that the MIC is 8 octets) and L=2 (indicating that the Length field is 2 octets, which is sufficient to hold the length of the largest possible IEEE 802.11 MPDU, expressed in octets). CCMP-256 uses M=16 (indicating that the MIC is 16 octets), and L=2 (indicating that the Length field is 2 octets, which is sufficient to hold the length of the largest possible IEEE 802.11 MPDU, expressed in octets).

FIG. 7 shows an example of attacking using an initial control frame.

STA MLD establishes a connection with an AP. The AP sends a MU-RTS trigger frame to STA1 as an initial control frame. An attacker AP can overhear the MU-RTS trigger frame. STA1 sends a CTS frame to the AP as a response to the MU-RTS trigger frame. STA1 can receive data from the AP.

The attacker AP may transmit a fake initial control frame (e.g., MU-RTS Trigger frame) to STA1 operating on the EMLSR mode. After receiving the fake initial control frame, the STA1 will respond with a CTS frame.

In consequence, the EMLSR STA cannot receive and transmit with its associated AP after receiving the fake initial control frame until it will switch back to the listening operation.

The fake initial control frame is transmitted by the attacker AP on behalf of the AP. STA1 acknowledges that the fake initial control frame is transmitted by the AP and falsely expects that the frame exchange with the AP will be initiated.

To provide initial control frame protection, the followings are proposed.

The initial control frame is a control frame transmitted by an AP or a STA. For example, the initial control frame is a control frame to initiate frame exchange between the AP and the STA. A trigger frame may be one type of the initial control frame. The trigger frame may be used to allocate resources for and solicit one or more PPDU transmission. The trigger frame may carry other information required by a responding STA to send a trigger-based (TB) PPDU.

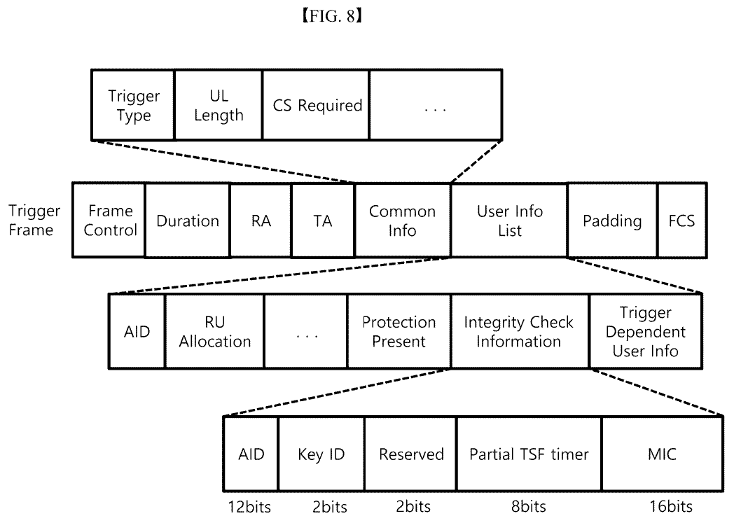

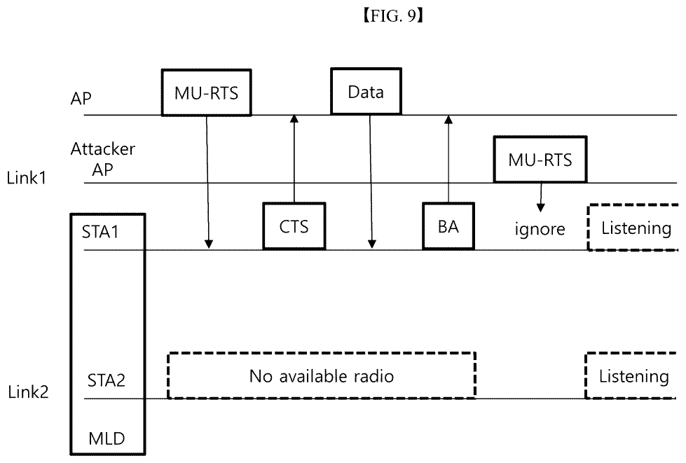

FIG. 8 shows an example of trigger frame format according an embodiment of the present disclosure. Not all (sub)fields are essential, and names and the number of bits for (sub)fields are for illustration purpose only.

A trigger frame may include a Common Info field and an User Info List field. The Common Info field may include a Trigger Type subfield, a UL Length subfield and a CS required subfield. The Trigger Type subfield identifies the type of the trigger frame. Types of trigger frame may include Basic, Beamforming Report Poll (BFRP), MU-BAR, MU-RTS, Buffer Status Report Poll (BSRP), etc. The UL Length subfield indicates the value of the L-SIG LENGTH field of the solicited TB PPDU. The CS Required subfield indicates that the STAs identified in the User Info fields are required to use energy detection to sense the medium and to consider the medium state and the NAV in determining whether to respond.

The User Info List field contains zero or more User Info fields. An User Info field may include an AID subfield, a RU allocation subfield, a Protection Present subfield, and a Trigger Dependent User Info subfield. An User Info field may further include an Integrity Check Information subfield, which is called as a Protection User Info field.

The AID subfield may include an identifier of the responding STA. The RU allocation subfield may indicate a resource for solicited TB PPDU.

The Protection Present subfield may indicate that Integrity Check Information is present in the trigger frame. For example, the Protection Present subfield is set to a first value (e.g., 1) when the Integrity Check Information subfield is present. Otherwise it is set to a second value (e.g., 0). The Protection Present subfield can be included in the Common Info field or in any places of the trigger frame.

The Integrity Check Information subfield includes integrity check information to calculate message integrity check (MIC) for protecting an integrity of the initial control frame. The integrity Check Information subfield (e.g., 5 byte) may include at least one of an AID subfield, an Key ID subfield, a Partial TSF timer subfield and an MIC subfield.

To protect the User Info field, the AID subfield of the Integrity Check Information subfield can be set to a specific value (e.g., 2006) to indicate the Protection User Info field. The Key ID subfield indicates the Key ID value of the associated beacon integrity group temporal key (BIGTK) of the AP. The Partial TSF Timer subfield indicates a part of the TSF timer of the AP. The Partial TSF Timer subfield may include the lowest n (e.g. n=8) bits of the TSF Timer value. The Partial TSF Timer subfield may include TSF timer [6:13].

The MIC subfield may include an MIC. The MIC may include Truncate-16 (Cipher-based message authentication code (CMAC) Output), which checks the integrity of the Common Info and User Info List fields (but not including the Protection User Info). Padding and FCS may not be included in the MIC calculation.

The AP which is a transmitting STA of the trigger frame can calculate the MIC of the trigger frame through Broadcast/multicast integrity protocol (BIP)-CMAC-128. BIP-CMAC-128 provides data integrity and replay protection, using AES-128 in CMAC Mode with a 128-bit integrity key and a CMAC TLen value of 128 (16 octets). The CMAC output for BIP-CMAC-128 is truncated to 16 bits: MIC=Truncate-16 (CMAC Output).

To verify the link that the trigger frame is transmitted, the Address 2 field (BSSID) may be included in the AAD construction.

The STA which receives the trigger frame can calculate an MIC based on the received trigger frame. In the MIC calculation, the Packet Number (PN) can be generated by concatenating the value of the partial TSF timer subfield in the Integrity Check Information of the received trigger frame and a part of the STA's local TSF timer. (e.g., [14:53]), For example, PN=PN0||PN1||PN2||PN3||PN4||PN5=TSF timer [6:53]. The PN can be generated by concatenating (or combining) at least one of the value of the partial TSF timer subfield, the STA's local TSF timer, a counter, a link identifier and an additional value.

FIG. 9 shows a protection of an initial control frame according an embodiment of the present disclosure.

STA1 establishes a connection with the AP and keeps same TSF Timer with the AP by receiving a beacon frame from the AP. A MU-RTS is an example of an initial control frame.

The AP can generate the MU-RTS with integrity check information. The integrity check information has a first MIC for the MU-RTS and a partial TSF timer which is a part of the AP's TSF timer. The first MIC may include Truncate-16 (CMAC Output).

When STA1 receives a MU-RTS as an initial control frame, STA1 can confirm that the MU-RTS has the integrity check information. For example, STA1 can decode the integrity check information when the Protection Present subfield of the trigger frame indicates that the integrity check information is present in the MU-RTS.

STA1 can determine the first MIC based on the integrity check information. STA1 can derive the first MIC from the MIC subfield of the integrity check information.

STA1 can determine a second MIC based in part on the receievd MU-RTS. STA1 can determine the second MIC based on at least one of STA1's TSF timer and the integrity check information. For example, STA1 can calculate the second MIC based on at least one of a part of STA1's TSF timer and a part of AP's TSF timer in the integrity check information. The Packet Number to calculate the second MIC can be generated by concatenating the value of the partial TSF timer subfield in the integrity check information and a part of the STA's local TSF timer.

When the first MIC matches with the second MIC, STA1 can confirm that the received initial control frame is actually transmitted by STA1's associated AP. When the first MIC does not match with the second MIC, STA1 can ignore (or discard) the received initial control frame as an invalid initial control frame.

In the MIC calculation, instead of using the BIGTK, any other group temporal key can be used. For example, a group temporal key can be defined for the Control frame protection. Since the TSF is used as the PN, whenever TSF timer [6:53] composing the PN wrap-arounds, the AP can update the group temporal key used for the Control frame protection.

As used herein, a phrase referring to “at least one of” or “one or more of” a list of items refers to any combination of those item, including single members. For example, “at least one of: a, b, and c” is intended to cover the possibilities of: a only, b only, c only, a combination of a and b, a combination of a and c, a combination of b and c, and a combination of a and b and c.

The various illustrative components, logic, logical blocks, modules, circuits, operations and algorithm processes described in connection with the implementations disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

While operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some cir-cumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

1-12. (canceled)

13. A method for protecting a control frame in a wireless local area network, the method performed by a station and comprising:
establishing a connection with an access point (AP);
receiving a trigger frame for allocating resources one or more physical layer protocol data unit (PPDU) transmission from the AP, the trigger frame including:
resource information for allocating the resources,
a protection present subfield indicating that the trigger frame is protected using message integrity check (MIC) algorithm,
key information indicating an integrity key,
packet number (PN) information including a PN corresponding to the integrity key indicated by the key information, and
MIC information indicating a first MIC calculated over the trigger frame;
computing a second MIC based on the received trigger frame; and
verifying the trigger frame based on the first MIC and the second MIC.

14. The method of claim 13, wherein verifying the trigger frame based on the first MIC and the second MIC includes:
discarding the received trigger frame when the first MAC does not match with the second MIC.

15. The method of claim 13, wherein the PN information and the MIC information are not present in the trigger frame when the protection present subfield in the trigger frame does not indicate that the trigger frame is protected.

16. The method of claim 13, wherein the protection present subfield in the trigger frame is set to 1 when the protection present subfield indicates that the trigger frame is protected.

17. The method of claim 13, wherein the second MIC is computed over the received trigger frame based on the integrity key indicated by the key information.

18. The method of claim 13, wherein the integrity key includes a group temporal key used for a control frame integrity, and the PN is maintained for each integrity key.

19. The method of claim 13, wherein the first MIC is generated based on an Additional Authentication Data (AAD) which is constructed from a header of the trigger frame, the header for constructing the AAD including a transmitter address.

20. A device for a wireless local area network, the device comprising:
a processor; and
a memory operatively coupled with the processor and configured to store instructions that, when executed by the processor, cause the device to perform functions comprising:
establishing a connection with an access point (AP);
receiving a trigger frame for allocating resources one or more physical layer protocol data unit (PPDU) transmission from the AP, the trigger frame including:
resource information for allocating the resources,
a protection present subfield indicating that the trigger frame is protected using message integrity check (MIC) algorithm,
key information indicating an integrity key,
packet number (PN) information including a PN corresponding to the integrity key indicated by the key information, and
MIC information indicating a first MIC calculated over the trigger frame;
computing a second MIC based on the received trigger frame; and
verifying the trigger frame based on the first MIC and the second MIC.

21. The device of claim 20, wherein verifying the trigger frame based on the first MIC and the second MIC includes:
discarding the received trigger frame when the first MAC does not match with the second MIC.

22. The device of claim 20, wherein the PN information and the MIC information are not present in the trigger frame when the protection present subfield in the trigger frame does not indicates that the trigger frame is protected.

23. The device of claim 20, wherein the protection present subfield in the trigger frame is set to 1 when the protection present subfield indicates that the trigger frame is protected.

24. The device of claim 20, wherein the second MIC is computed over the received trigger frame based on the integrity key indicated by the key information.

25. The device of claim 20, wherein the integrity key includes a group temporal key used for a control frame integrity, and the PN is maintained for each integrity key.

26. The device of claim 20, wherein the first MIC is generated based on an Additional Authentication Data (AAD) which is constructed from a header of the trigger frame, the header for constructing the AAD including a transmitter address.
